(19) United States
(12) Patent Application Publication
(10) Pub. No.: US 2002/0108609 A1
(43) Pub. Date: Aug. 15, 2002

(54) Quick disconnect device

(76) Inventor: John I. Elkins, St. James, NY (US)

Correspondence Address: K. Scott O'Brian, Esq., Greensfelder, Hemker & Gale, P.C., Intellectual Property Group, 10 South Broadway, Suite 2000, St. Louis, MO, 63102-1774, US

(21) Appl. No.: 09/779,962

(22) Filed: Feb. 9, 2001

Related U.S. Application Data
(60) Provisional application No. 60/204,953, filed on May 17, 2000.

(51) Int. Cl. A62B 9/00

(52) U.S. Cl. 128/200.24

(57) ABSTRACT

A method and apparatus for providing rapid and secure fluid tight connections between components of a ventilation circuit. Quick disconnect device is disclosed having a hollow receiving member defining multiple apertures formed therethrough, each aperture receiving a retaining ball in inward and outward movement therein. The receiving member is attached to a component or to one end of the ventilation circuit. The quick disconnect device further includes an elongated conical member having a recessed region formed therealong with the receiving member being adapted to receive the conical member therein. The conical member is attached to another component or to the other end of the ventilation circuit. To establish a secure connection, a collar is passed over the receiving member for urging the retaining balls in an inward direction. The receiving member is then passed over the conical member until the retaining balls are properly aligned with the recessed region so that the collar passes over the receiving member and urges the retaining balls into secure engagement with the recessed region.

### CROSS-REFERENCE TO RELATED APPLICATIONS

This application is based upon Provisional Patent Application, Serial No. 60/204,953, entitled “Integrated Respiratory/Ventilation System For Improved Patient Care”, filed May 17, 2000, the contents of which are incorporated herein by reference in their entirety and continued preservation of which is requested.

### BACKGROUND OF THE INVENTION

1. Field of the Invention

The present invention relates to quick release devices, and more particularly to quick release devices used in the medical field. More specifically, the present invention relates to quick release devices used to provide rapid and secure fluid tight connections between components of a ventilation circuit.

2. Prior Art

There are many medical conditions that require a patient to receive oxygen or medication administered by a respiratory support system using a ventilation circuit to interconnect various components of the system. When attached to a patient, the entire respiratory support system is designed to isolate the patient's lungs from the atmosphere and allow pressurized forced ventilation of a gas mixture having a high oxygen content from the respiratory support system into the patient's lungs. Commonly, respiratory support systems of this type are used to maintain a positive end expiratory pressure (PEEP) within the ventilator manifold attached to the patient and the patient's lungs at all times during exhalation. Additionally, the ventilator also delivers a pre-programmed volume or “breath” to a patient during inhalation. This technique is used because of its benefit of ensuring that a minimum concentration of oxygen is supplied to the patient in order to maintain proper blood oxygen levels. The positive end expiratory pressure procedure keeps a large number of lung alveoli of the patient open at all times during respiratory support, thereby increasing the effective lung area exposed to ventilation. Unfortunately, whenever a connecting joint in the ventilation circuit becomes disconnected a patient in a weakened state may be unable to intervene on their own behalf. When a disconnection occurs the respiratory support system loses positive end expiratory pressure, which can seriously impair the patient's breathing functions. Therefore, the requirement that all connecting joints remain securely fastened is absolutely critical to the well being of the patient.

In addition to stable, securely fastened connecting joints, it is equally critical that hospital staff are able to quickly provide treatment to a patient which may entail the addition or removal of components in a ventilation circuit.

One group of connectors that are typically used include those which connect and disconnect endotracheal and tracheostomy tubes to the ventilation circuit. The connectors generally have an elbow configuration and provide a press-fit connection between the connector and the ventilation tubing of the ventilation circuit. A problem with the known art connectors is that accidental disconnection of the ventilation circuit from the endotracheal or tracheostomy tubes can occur on a frequent basis. To prevent an accidental disconnection, additional force or pressure must be applied by medical staff to an elbow connector in order to securely engage the endotracheal or tracheostomy tube with the ventilation circuit. However, such manipulation of the elbow connector can cause pressure on the trachea of the patient, thereby causing severe discomfort and often gagging of the patient due to the lack of stability in the overall connection of the ventilation circuit.

Additionally, connectors of this character must be compatible with certain industry specifications in order to achieve status as certified medical equipment. Industry requirements for connectors are provided in both the ASTM (American Society for Testing and Materials) and ISO (International Organization for Standardization) standards, namely, ASTM 11/22MM and ISO 5356-1 2nd Ed., wherein the minimum length of tapers for both female connectors and male cones, and the minimum clearance to a shoulder for conical connectors are specified. The standards also provide the maximum radius on the entrance to the female connector and on the leading edge of the male cone. However, prior art connectors utilizing tapered connectors in accordance with industry specifications lack a positive locking feature.

Therefore, there appears a need in the art for a quick release device that establishes a robust, secure connection between components in a ventilation circuit that is compatible with existing industry specifications.

### OBJECTS AND SUMMARY OF THE INVENTION

The primary object of the present invention is to provide a quick release device that establishes a robust, secure connection between components in a ventilation circuit.

Another object of the present invention is to provide a quick release device that is compatible with existing ventilation circuit components.

A further object of the present invention is to provide a quick release device that is simple to use and inexpensive to manufacture.

These and other objects of the present invention are realized in the preferred embodiment of the present invention, described by way of example and not by way of limitation, which provides for a quick release device for a ventilation circuit.

In brief summary, the present invention overcomes and substantially alleviates the deficiencies in the prior art by providing an apparatus and method for providing rapid and secure fluid tight connections between components of a ventilation circuit. The apparatus comprises a receiving member which includes a hollow conical body having opposed first and second openings that define a tapered channel therebetween of decreasing cross section while proceeding from the first opening toward the second opening. The conical body further has an outside surface and a plurality of apertures formed therethrough with each aperture securing a retaining ball in inward and outward movement therein. The apparatus further comprises an elongated conical member having a proximal end and a distal end which defines a recessed region therebetween. The conical member defines a tapered surface of increasing cross section while proceeding from the proximal end toward the distal end. In assembly, the first opening of the receiving member is sized and shaped to receive one end of the conical member therein. A collar is provided for locking the receiving member to the conical member and is slidably engageable along the outside surface of the conical body for urging the retaining balls inwardly. When the first opening of the receiving member passes over the proximal end of conical member, the collar then slidably engages the outside surface of the body which urges the retaining balls into secure engagement with the recessed region.

The present invention further contemplates a method of combining a plurality of receiving members, conical members and collars together in order to establish secure, fluid tight connections between various components of the ventilation circuit as well as permitting rapid component replacement or removal of various components in the ventilation circuit.

Additional objects, advantages and novel features of the invention will be set forth in the description which follows, and will become apparent to those skilled in the art upon examination of the following more detailed description and drawings in which like elements of the invention are similarly numbered throughout.

### BRIEF DESCRIPTION OF THE DRAWINGS

FIG. 1 is an exploded perspective view of a quick disconnect device according to the present invention;

FIG. 2 is a cross sectional view of a prior art disconnect device;

FIG. 3 is a cross sectional view of the quick disconnect device taken along line A-A of FIG. 1 according to the present invention;

FIG. 4 is a perspective view of the quick disconnect device in its assembled condition according to the present invention;

FIG. 5 is another cross sectional view of the prior art disconnect device;

FIG. 6 is a cross sectional view of the quick disconnect device taken along line B-B of FIG. 4 according to the present invention;

FIG. 7 is an exploded perspective view of an alternate embodiment of the quick disconnect device according to the present invention;

FIG. 8 is an exploded perspective view of a further alternate embodiment of the quick disconnect device according to the present invention;

FIG. 9 is an exploded perspective view of another further alternate embodiment of the quick disconnect device according to the present invention; and

FIG. 10 is an exploded perspective view of an additional embodiment of the quick disconnect device according to the present invention.

### DETAILED DESCRIPTION OF THE INVENTION

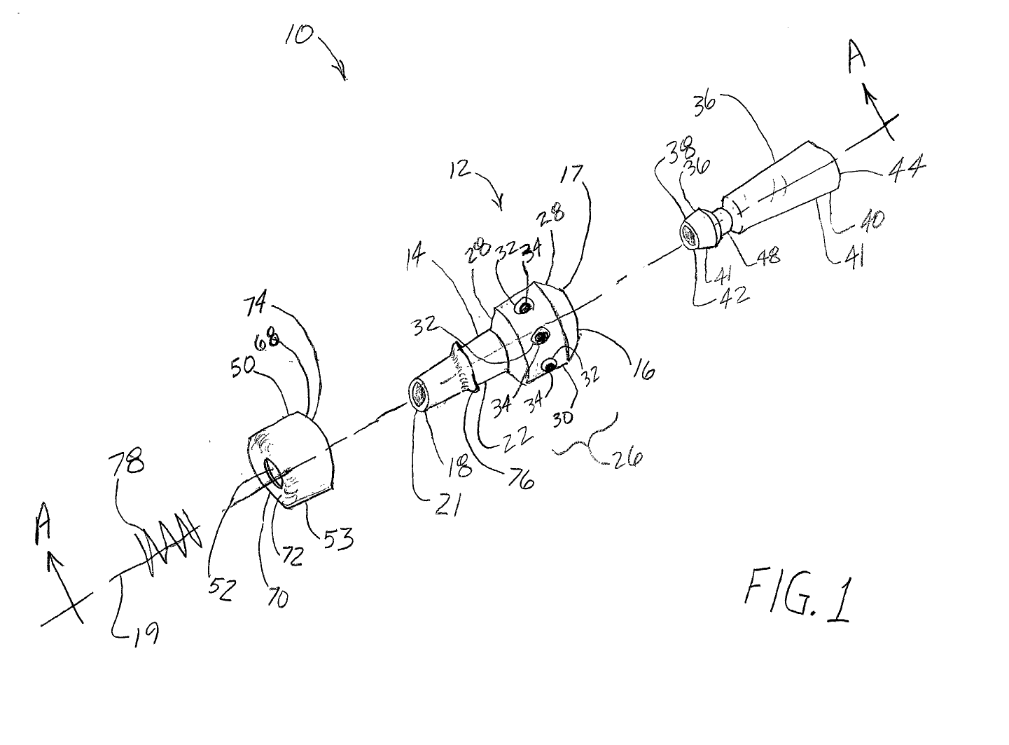

Referring to the drawings, the preferred embodiment of the quick disconnect device of the present invention is illustrated and generally indicated as 10 in FIG. 1. Quick disconnect device 10 comprises a receiving member 12 for slideably receiving a conical member 36 and a collar 50 which is passed over receiving member 12 for securing conical member 36 to receiving member 12.

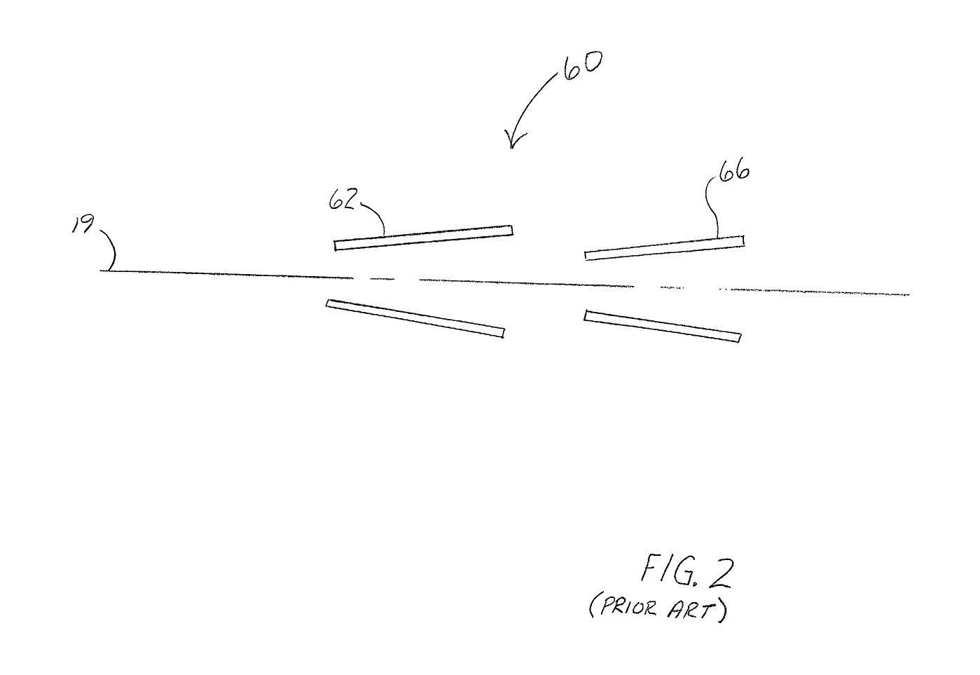

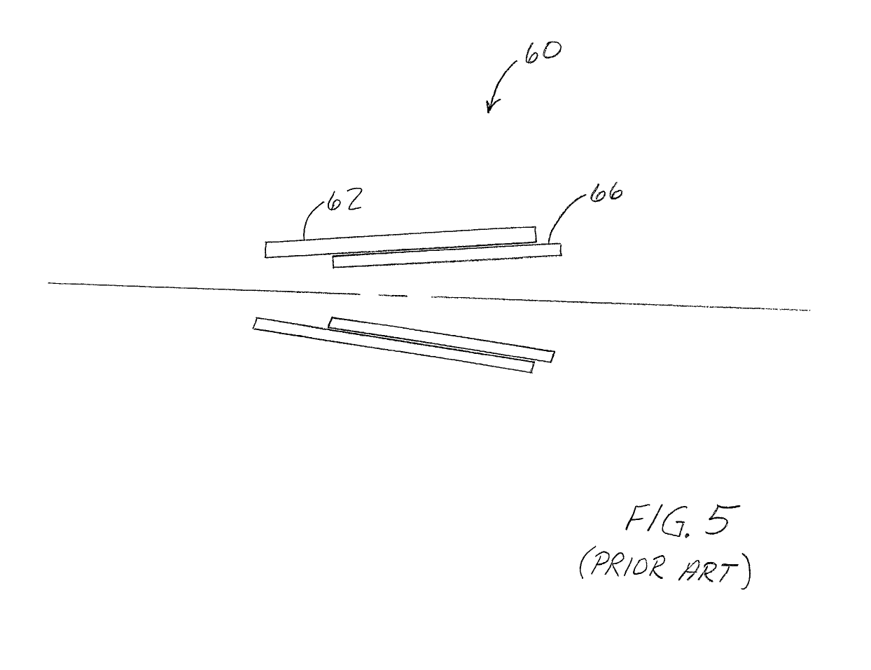

Referring to FIGS. 2 and 5, the prior art disconnect device 60 shall now be discussed. The prior art disconnect device 60 comprises a receiving member 62 which differs from receiving member 12 of the present invention in that prior art receiving member 62 lacks a frustoconical portion 26. Further, the prior art disconnect device 60 includes a conical member 66 which differs from conical member 36 of the present invention in that prior art conical member 36 lacks a recessed portion 48 as will also be discussed in greater detail below. Finally, the prior art disconnect device 60 lacks any kind of collar 50. As illustrated specifically to FIG. 5, prior art disconnect device 60 simply forms a press-fit engagement between receiving member 62 and conical member 66 which lacks the robust, secure connection now possible with quick disconnect device 10 of the present invention.

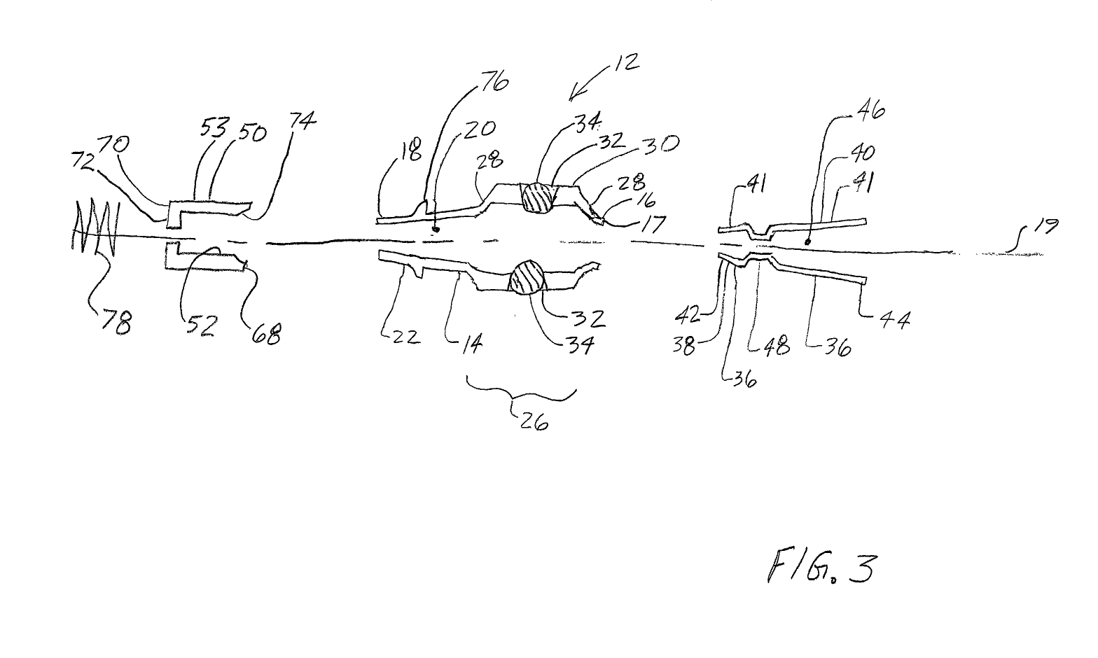

Referring to FIGS. 1 and 3, receiving member 12 comprises a hollow conical body 14 having opposed distal or first end 17 and proximal or second end 21, respectively. Receiving member 12 further comprises a frustoconical portion 26 extending from one end of conical portion 22 along a longitudinal axis 19. Preferably, at the midpoint along the length of conical portion 22, a raised region 76 is formed for engagement with a resilient member 78 as will be discussed in greater detail below. Raised region 76 may also be effected by adhering an annular ring (not shown) at the desired location along conical portion 22. As further shown, frustoconical portion 26 forms opposing sloped edges 28 having an annular outside surface 30 formed between edges 28. Outside surface 30 includes a plurality of apertures 32 formed therethrough with each aperture 32 having a retaining ball 34 disposed therein. Preferably, apertures 32 are sized and shaped to permit radial movement of retaining ball 34, i.e., conical shaped with the diameter of aperture 32 opposite outside surface 30 being slightly less than the diameter of retaining ball 34 for permitting partial inward movement of retaining ball 34 within aperture 32, although inward and outward movement is also felt to fall within the scope of the present invention. Referring specifically to FIG. 3, a first opening 16 is formed along proximal end 17, while conical portion 22 defines a second opening 18 formed along distal end 21. A tapered channel 20 is defined between first and second openings 16 and 18 for receiving conical member 36 therein. As further shown, tapered channel 20 defines an area of increasing cross section proceeding in a direction from second opening 18 toward first opening 16 which is similar to the profile defined by conical member 36. Preferably, conical portion 22 which defines tapered channel 20 is of uniform wall thickness.

Referring back to FIGS. 1 and 3, conical member 36 comprises a conical head portion 38 having a proximal end 42 defining a tapered outside surface 41 adapted for insertion through first opening 16 of receiving member 12. Conical member 36 further comprises a shaft 40 having a distal end 44 which may also be at least partially inserted through first opening 16. As further shown, a recessed region 48 is defined between head portion 38 and shaft 40 for receiving retaining balls 34 as shall be explained in greater detail below. A channel 46 is formed between proximal and distal ends 42 and 44 for permitting fluid communication through conical member 36.

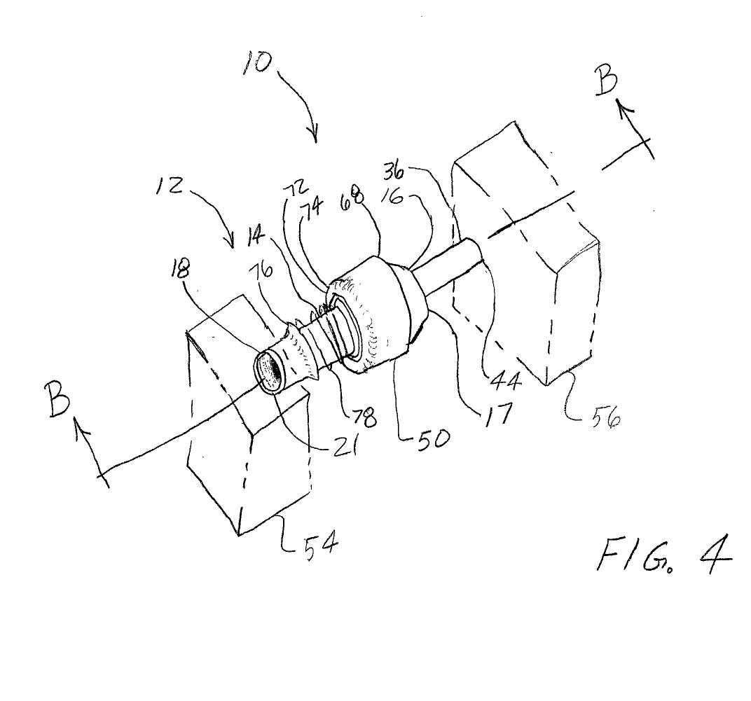

Referring to FIG. 4, quick disconnect device 10 is shown in its connected condition in a ventilation circuit (not shown) In its simplest form, one end of the ventilation circuit is securely attached to distal end 44 of conical member 36, while the other end of a ventilation circuit is securely attached to second opening 18 of receiving member 12. Additional components, such as nebulizer wyes, or resuscitator bags, may be added to the ventilation circuit to provide respiratory therapy to a patient. As further shown, a first component 54 may be added to the ventilation circuit by securely attaching one end of component 54 to the second opening 18 of receiving member 12, while the other end of component 54 is securely attached to one end of the ventilation circuit. Similarly, a second component 56 may be added to the ventilation circuit by securely attaching one end of component 56 to the distal end 44 of conical member 36 and securely attaching the other end of component 56 to the other end of the ventilation circuit. One skilled in the art can appreciate that any number of components having fittings compatible with receiving member 12 or conical member 36 may be added to a ventilation circuit.

Referring back to FIGS. 1 and 3, annular collar 50 provides a secure connection between receiving member 12 and conical member 36 and defines opposing proximal and distal ends 68 and 70 and an inner surface 52 sized and shaped to closely and slidably engage along outside surface 30 of receiving member 12 such that retaining balls 34 are forced radially inward. Collar 50 further includes a shoulder 72 which extends from distal end 70 and prevents collar 50 from sliding all the way over outside surface 30. Shoulder 72 abuts sloped edge 28 of frustoconical portion 26 after proximal end 68 is slid over outside surface 30 and inner surface 52 has forced retaining balls 34 radially inward. Proximal end 68 further includes a tapered portion 74 that permits a user to more easily slide collar 50 over retaining balls 34 which protrude from outside surface 30. To more easily permit a user to grasp collar 50 for sliding engagement along outside surface 30, a nonslip outside surface 53 may be provided by scuffing or by any number of manufacturing processes known in the art.

Once installed, it is desirable to maintain inner surface 52 of collar 50 over retaining balls 34 to prevent balls 34 from falling out. Raised region 76 which establishes an area of increased outer diameter larger than the inner diameter of shoulder 72 prevents the inadvertent removal of collar 50 from conical member 22. Preferably raised region 76 may be integrally formed in any number of profiles as part of conical member 22, as long as shoulder 72 initially slides over raised region 76. An additional requirement for raised region 76 is that the surface facing sloped edge 28 extend substantially perpendicular from conical member 22 for abutting resilient member 78. Alternately, annular ring (not shown) could be adhered at the desired location along conical member 22 after collar 50 is installed. To further help maintain collar 50 in its installed position, resilient member 78, preferably a spring, may be slid over raised region 76 thereby interposing resilient member 78 between raised region 76 and shoulder 72. Therefore, collar 50 may be slid along longitudinal axis 19 over conical member 22 in a direction away from frustoconical portion 26 to the extent that retaining balls 34 contact inner surface 52 along tapered portion 74. Upon contacting tapered portion 74, retaining balls 34 are permitted to move sufficiently in an outward direction to become disengaged from recessed region 48 in conical member 36, thereby permitting removal of conical member 36. If installation of conical member 36 is desired, to permit retaining balls 34 to slide over conical head portion 38 so that alignment and engagement with recessed region can occur. In operation, it is assumed that raised region 76 and resilient member 78 have already been installed onto receiving member 12.

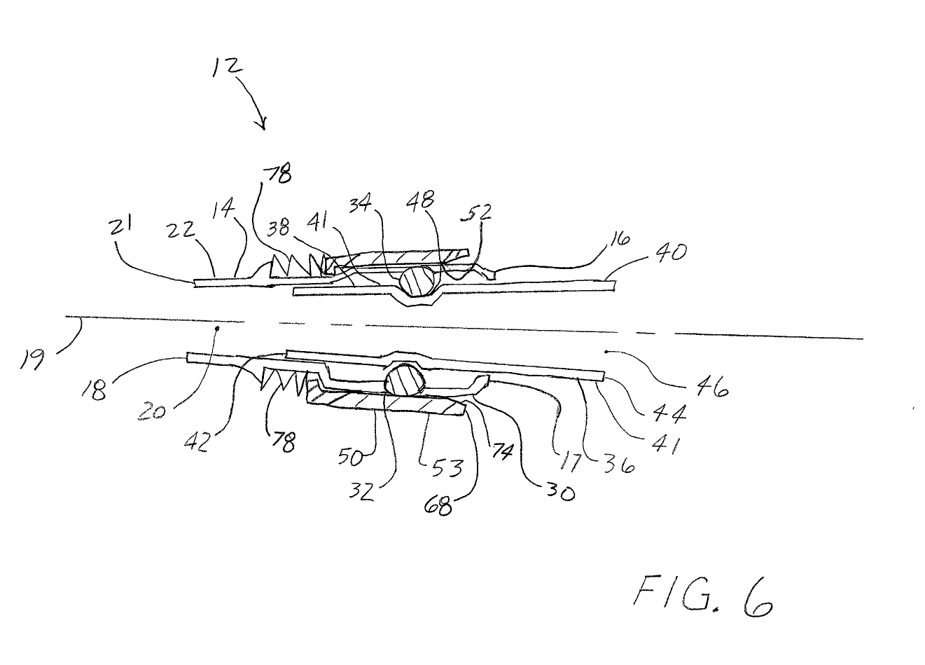

Referring to FIGS. 1, 3, 4 and 6, the operation of quick disconnect device 10 shall be discussed. In operation, a user (not shown) grasps outside surface 30 of receiving member 12 in one hand, while grasping outside surface 41 of conical member 36 with the other hand. The user then aligns receiving member 12 with conical member 36 along longitudinal axis 19. After aligning receiving member 12 and conical member 36, the user directs collar 50 against resilient member 78 and directs first opening 16 over head portion 38 while applying continued force along longitudinal axis 19. The continued force incrementally passes first opening 16 over head portion 38 until retaining balls 34 are properly aligned with recessed region 48. The user then directs collar 50 along longitudinal axis 19 such that collar 50 passes over second conical portion 22 until shoulder 72 abuts sloped edge 28. As the inside surface 52 of collar 50 passes over apertures 32, inside surface 52 contacts and directs retaining balls 34 inwardly in a radial direction. Referring to FIG. 6, the inwardly directed retaining balls 34 are brought into engagement with recessed region 48 of conical member 36 such that a secure connection is achieved between receiving member 12 and conical member 36. The secure engagement is established because retaining balls 34 form a region of decreased inside diameter within tapered channel 20 that is less than the outside diameter on either side of recessed region 48 so that there can be substantially no movement along longitudinal axis 19 between receiving member 12 and conical member 36.

One skilled in the art can appreciate that by directing collar 50 along longitudinal axis 19 away from conical member 36 until resilient member 78 is sufficiently compressed between raised region 76 and shoulder 72 and tapered portion 74 positioned over apertures 32, retaining balls 34 are permitted to more freely move outwardly. Preferably retaining balls 34 move outwardly in a radial direction, until balls 34 are disengaged from recessed region 48. Once recessed region 48 is disengaged from retaining balls 32, the user may apply opposing forces along longitudinal axis 19 to break the connection between receiving member 12 and conical member 36.

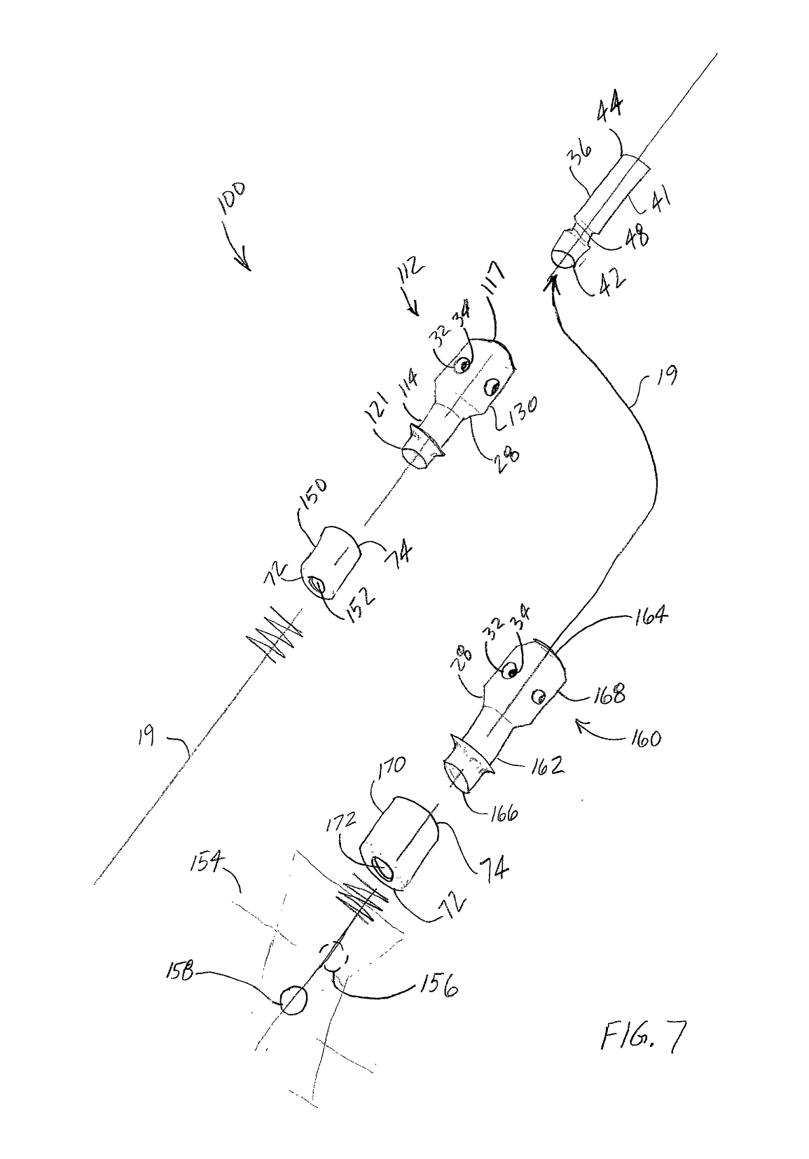

Referring to FIG. 7, an alternate embodiment of quick disconnect device 100 shall be discussed. Disconnect device 100 comprises a first receiving member 112 having a first conical body 114 defining a first end 117 and a second end 121 connected to one end of the ventilation circuit. First collar 150 is otherwise similar to collar 50 of the preferred embodiment. As further shown, a first collar 150 having an inside surface 152 for slidably engaging first outside surface 130 is provided which is slidably captured by the connection between second end 121 and the one end of the ventilation circuit. With the additional exception of first outside surface 130, first receiving member 112 is otherwise similar to receiving member 12 of the preferred embodiment. Similarly, a second receiving member 160 includes a second conical body 162 having a third end 164, and a fourth end 166 for receiving a first component 154 which provides respiratory therapy to a patient. Second receiving member 160 further includes a second outside surface 168 and is also otherwise similar to receiving member 12 of the preferred embodiment. First component 154 has a first proximal end 156 securely connected to fourth end 166 and a first distal end 158 for connection to one end of the ventilation circuit. Slidably captured by the connection between fourth end 166 and first proximal end 156 is a second collar 170 having an inside surface 172 for slidably engaging second outside surface 168. Second collar 170 is otherwise similar to collar 50 of the preferred embodiment. Slidably receivable in both first end 117 and third end 164 is proximal end 42 of conical member 36 which includes distal end 44 for connecting to the other end of the ventilation circuit. Formed between proximal end 42 and distal end 44 is a recessed region 48 for engagement with first and second receiving members 112 and 160, respectively.

The operation of quick disconnect device 100 shall be now be discussed. In operation, a user (not shown) grasps first outside surface 130 of first receiving member 112 in one hand, while grasping outside surface 41 of conical member 36 with the other hand. Following the procedure previously discussed above, the user directs first end 117 over proximal end 42 and applies continued force along longitudinal axis 19 to incrementally pass first end 117 over proximal end 42 until retaining balls 34 are properly aligned with recessed region 48. The user then directs first collar 150 along longitudinal axis 19 such that first collar 150 passes over first outside surface 130 until shoulder 72 abuts sloped edge 28. As the inside surface 152 of collar 150 passes over apertures 32, inside surface 152 contacts and directs retaining balls 34 inwardly in a radial direction which engage recessed region 48 such that a secure connection is achieved between first receiving member 112 and conical member 36.

As previously described above, by directing first collar 150 along longitudinal axis 19 away from conical member 36 until tapered portion 74 of first collar 150 is positioned over apertures 32, retaining balls 34 are permitted to more freely move outwardly, preferably in a radial direction, until disengaged with recessed region 48. Once recessed region 48 is disengaged from retaining balls 34, the user may apply opposing forces along longitudinal axis 19 to break the connection between first receiving member 112 and conical member 36. The user then applies an opposing force along longitudinal axis 19 between second end 121 and one end of the ventilation circuit until the connection is broken between second end 121 and the ventilation circuit, thereby removing the first receiving member 112 from the ventilation circuit.

Second receiving member 160 which is connected to first component 154 may now be installed in the ventilation circuit in place of the removed first receiving member 112. The user grasps the one end of the ventilation circuit previously connected to second end 121 in one hand and first component 154 in the other hand and directs first distal end 158 of first component 154 toward each other along longitudinal axis 19 until a secure connection is established between first component 154 and one end of the ventilation circuit. As previously described above, the user directs third end 164 over proximal end 42 and applies continued force along longitudinal axis 19 to incrementally pass second end 164 over proximal end 42 until retaining balls 34 are properly aligned with recessed region 48. The user then directs second collar 170 along longitudinal axis 19 such that second collar 170 passes over second outside surface 168 until shoulder 72 abuts sloped edge 28. As second inside surface 172 of second collar 170 passes over apertures 32, second inside surface 172 contacts and forces retaining balls 34 inwardly in a radial direction which engage recessed region 48 such that a secure connection is achieved between second receiving member 160 and conical member 36.

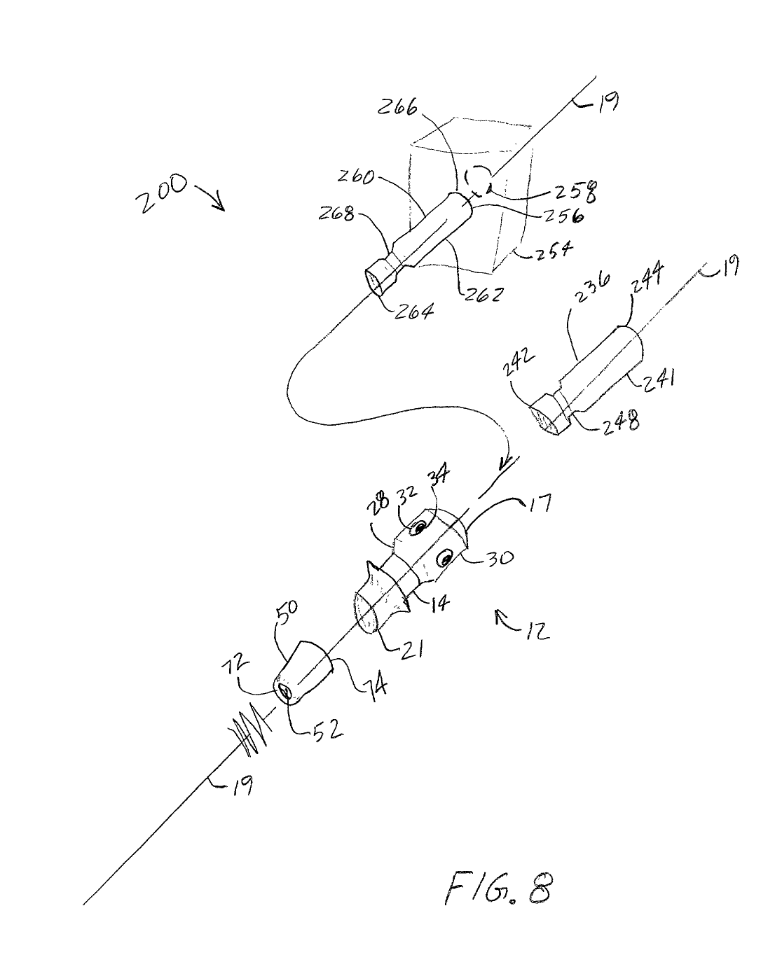

Referring to FIG. 8, an additional alternate embodiment of quick disconnect device 200 shall be discussed. Disconnect device 200 comprises receiving member 12, which is identical to the preferred embodiment, for connecting to one end of the ventilation circuit at second end 21. As further shown, collar 50 having an inside surface 52 for slidably engaging outside surface 30 is provided which is slidably captured by the connection between second end 21 and one end of the ventilation circuit. As previously described above, receiving member 12 is identical to the preferred embodiment and secures first and second conical members 236 and 260, respectively. Slidably receivable in first end 17 is a proximal end 242 of first conical member 236 which includes a first outside surface 241 and a distal end 244 that is securely connected to the other end of the ventilation circuit. Formed between proximal end 242 and distal end 244 is a first recessed region 248 that is engageable with retaining balls 34. Also slidably receivable in first end 17 is a second proximal end 264 of a second conical member 260 including a second outside surface 262 and a second distal end 266 that is securely connected to a first proximal end 256 of a first component 254. Formed between second proximal end 264 and second distal end 266 is a second recessed region 268 that is engageable with retaining balls 34. First component 254 provides respiratory therapy to a patient and further includes a first distal end 258 for securely connecting to the other end of the ventilation circuit.

The operation of quick disconnect device 200 shall be now be discussed. In operation, a user grasps outside surface 30 of receiving member 12 in one hand, while grasping first outside surface 241 of first conical member 236 with the other hand. Following the procedure previously discussed, the user directs first end 17 over proximal end 242 and applies continued force along longitudinal axis 19 to incrementally pass first end 17 over proximal end 242 until retaining balls 34 are properly aligned with first recessed region 248. The user then directs collar 50 along longitudinal axis 19 such that collar 50 passes over outside surface 30 until shoulder 72 abuts sloped edge 28. As inside surface 52 of collar 50 passes over apertures 32, inside surface 52 contacts and directs retaining balls 34 inwardly in a radial direction which engage first recessed region 248 such that a secure connection is achieved between receiving member 12 and first conical member 236.

As previously described above, by directing collar 50 along longitudinal axis 19 away from first conical member 236 until tapered portion 74 of collar 50 is positioned over apertures 32, retaining balls 34 are permitted to more freely move outwardly, preferably in a radial direction, until disengaged from first recessed region 248. Once first recessed region 248 is disengaged from retaining balls 34, the user may apply opposing forces along longitudinal axis 19 to break the connection between receiving member 12 and first conical member 236. The user then applies opposing force along longitudinal axis 19 between distal end 244 and one end of the ventilation circuit until the connection is broken between distal end 244 and the one end of the ventilation circuit, thereby removing first conical member 236 from the ventilation circuit.

Second conical member 260 which is connected to first component 254 may now be installed in the ventilation circuit in place of the removed first conical member 236. The user grasps the one end of the ventilation circuit previously connected to distal end 244 in one hand and first component 254 in the other hand and directs first distal end 258 of first component 254 toward the one end of the ventilation circuit along longitudinal axis 19 until a secure connection is established between first component 254 and the one end of the ventilation circuit. As previously described, the user directs first end 17 over second proximal end 264 and applies continued force along longitudinal axis 19 to incrementally pass first end 17 over second proximal end 264 until retaining balls 34 are properly aligned with second recessed region 268. The user then directs collar 50 along longitudinal axis 19 such that collar 50 passes over outside surface 30 until shoulder 72 abuts sloped edge 28. As inside surface 52 of collar 50 passes over apertures 32, inside surface 52 contacts and directs retaining balls 34 inwardly in a radial direction which engage second recessed region 268 such that a secure connection is achieved between receiving member 12 and second conical member 260.

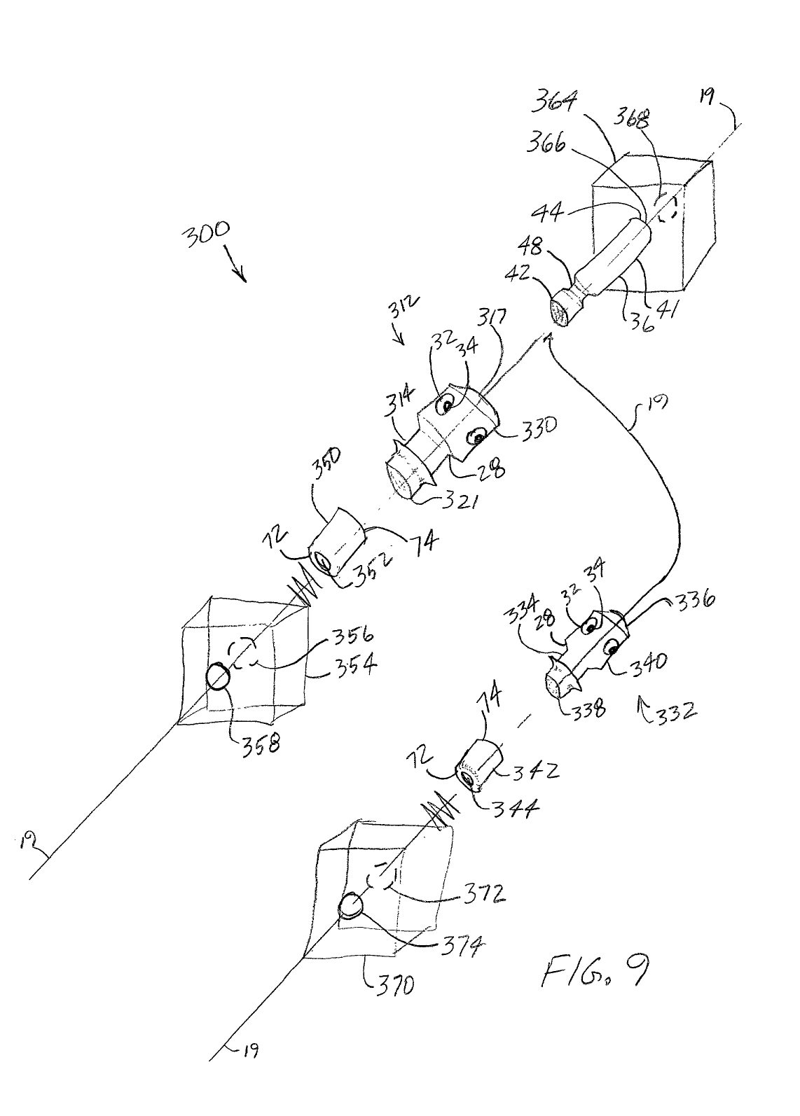

Referring to FIG. 9, another further alternate embodiment of quick disconnect device 300 shall be discussed. Disconnect device 300 comprises a first receiving member 312 having a first conical body 314 defining a first outside surface 330, a first end 317 and a second end 321 securely connected to a proximal end 356 of a first component 354 which provides respiratory therapy to a patient. In addition to connecting with first receiving member 312, first component 354 securely connects to one end of the ventilation circuit at distal end 358. As further shown, a first collar 350 having an inside surface 352 for slidably engaging first outside surface 330 is provided which is slidably captured by the connection between second end 321 and proximal end 356. As in the other alternate embodiments, first receiving member 312 is substantially similar to receiving member 12 of the preferred embodiment in configuration and operation. Likewise, a second receiving member 332 includes a second conical body 334 defining a third end 336 and a fourth end 338 for receiving a third component 370 which provides respiratory therapy to a patient. Second receiving member 332 further includes a second outside surface 340. Third component 370 has a third proximal end 372 securely connected to fourth end 338 and a third distal end 374 for connecting to one end of the ventilation circuit. Slidably captured by the connection between fourth end 338 and third proximal end 372 is a second collar 342 having an inside surface 344 for slidably engaging second outside surface 340. As further shown, slidably receivable in both first end 317 and third end 336 along outside surface 41 is proximal end 42 of conical member 36. Conical member 36 includes a distal end 44 for connection to a proximal end 366 of a second component 364 which provides respiratory therapy to the patient through the ventilation circuit. Formed between proximal end 42 and distal end 44 is a recessed region 48 for engagement with first and second receiving members 312 and 332, respectively. In addition to connecting with conical member 36, second component 364 securely connects to the other end of the ventilation circuit at distal end 368.

In operation, a user grasps first outside surface 330 of first receiving member 312 in one hand, while grasping outside surface 41 of conical member 36 with the other hand. Following the procedure previously discussed above, the user first directs first end 317 over proximal end 42 and applies continued force along longitudinal axis 19 to incrementally pass first end 317 over proximal end 42 until retaining balls 34 are properly aligned with recessed region 48. The user then directs first collar 350 along longitudinal axis 19 such that first collar 350 passes over first outside surface 330 until shoulder 72 abuts sloped edge 28. As the inside surface 352 of collar 350 passes over apertures 32, inside surface 352 contacts and forces retaining balls 34 inwardly in a radial direction into engagement with recessed region 48 such that a secure connection is achieved between first receiving member 312 and conical member 36.

As previously described above, by directing first collar 350 along longitudinal axis 19 away from conical member 36 until tapered portion 74 of first collar 350 is positioned over apertures 32, retaining balls 34 are permitted to more freely move outwardly, preferably in a radial direction, until disengaged from recessed region 48. Once recessed region 48 is disengaged from retaining balls 34, the user may apply opposing forces along longitudinal axis 19 to break the connection between first receiving member 312 and conical member 36. The user then applies opposing force along longitudinal axis 19 between distal end 358 and one end of the ventilation circuit until the connection is broken between distal end 358 and the ventilation circuit, thereby removing first receiving member 312 and first component 354 from the ventilation circuit.

Second receiving member 332 which is connected to third component 370 may now be installed in the ventilation circuit in place of the removed first receiving member 312 and first component 354. The user grasps the one end of the ventilation circuit previously connected to distal end 358 in one hand and third component 370 in the other hand and directs third distal end 374 of third component 370 toward each other along longitudinal axis 19 until a secure connection is established between third component 370 and one end of the ventilation circuit. As previously described above, the user directs third end 336 over proximal end 42 and applies continued force along longitudinal axis 19 to incrementally pass third end 336 over proximal end 42 until retaining balls 34 are properly aligned with recessed region 48. The user then directs second collar 342 along longitudinal axis 19 such that second collar 342 passes over second outside surface 340 until shoulder 72 abuts sloped edge 28. As second inside surface 344 of second collar 342 passes over apertures 32, second inside surface 344 contacts and forces retaining balls 34 inwardly in a radial direction which engage recessed region 48 such that a secure connection is achieved between second receiving member 332 and conical member 36.

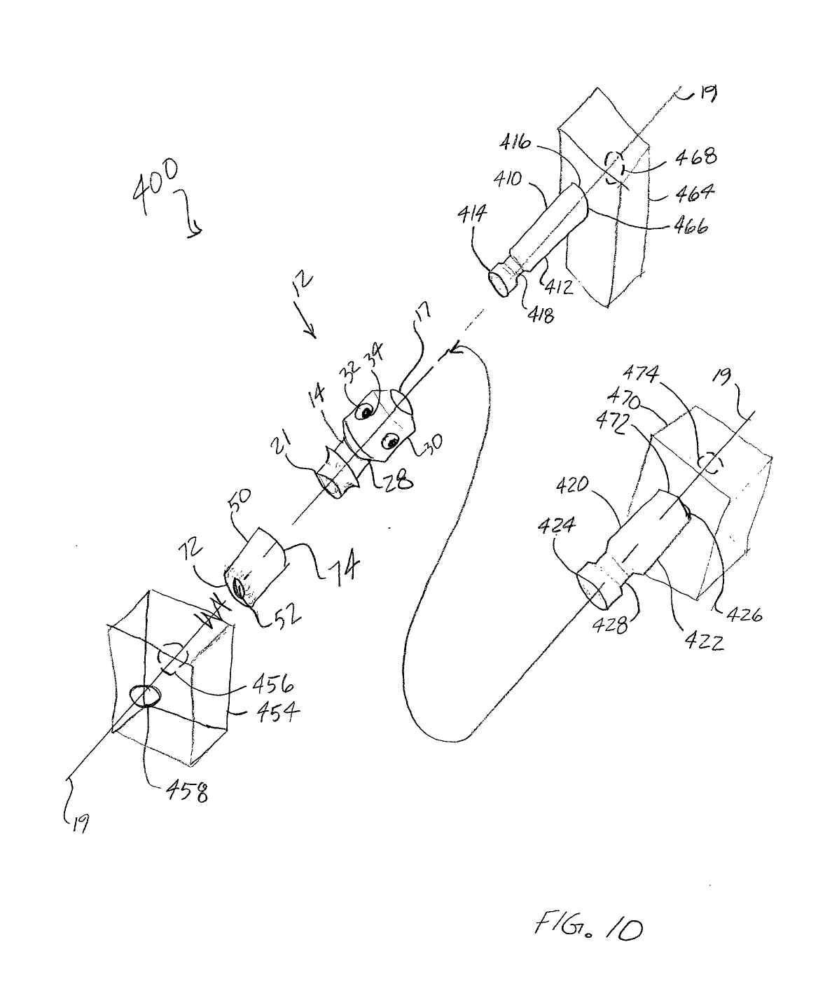

Referring to FIG. 10, a further alternate embodiment of quick disconnect device 400 shall be discussed. Disconnect device 400 comprises receiving member 12 which is substantially similar to the preferred embodiment. Connected to second end 21 of receiving member 12 is a proximal end 456 of a first component 454 for providing respiratory therapy to a patient. First component 454 additionally has a distal end 458 for securely connecting to one end of a ventilator circuit. As further shown, collar 50 having an inside surface 52 for slidably engaging outside surface 30 is provided which is slidably captured by the connection between second end 21 and proximal end 456 of first component 454. Further, receiving member 12 is configured for securely engaging first and second conical members 410 and 420, respectively. Slidably receivable in first end 17 of receiving member 12 is a proximal end 414 of a first conical member 410 which includes a first outside surface 412 and a distal end 416 that is securely connected to a proximal end 466 of second component 464 which provides respiratory therapy to a patient. Second component 464 additionally has a distal end 468 for securely connecting to one end of the ventilation circuit. Formed between proximal end 414 and distal end 416 is a first recessed region 418 that is engageable with retaining balls 34. Also slidably receivable in first end 17 is a second proximal end 424 of a second conical member 420 including a second outside surface 422 and a second distal end 426 that is securely connected to a third proximal end 472 of a third component 470. Formed between second proximal end 424 and second distal end 426 is second recessed region 428 which is engageable with retaining balls 34. Third component 470 provides respiratory therapy to a patient, and further includes a third distal end 474 for securely connecting to the other end of the ventilation circuit.

In operation, a user grasps outside surface 30 of receiving member 12 in one hand, while grasping first outside surface 412 of first conical member 410 with the other hand. Following the procedure previously discussed above, the user first directs first end 17 over proximal end 414 and applies continued force along longitudinal axis 19 to incrementally pass first end 17 over proximal end 414 until retaining balls 34 are properly aligned with first recessed region 418. The user then directs collar 50 along longitudinal axis 19 such that collar 50 passes over outside surface 30 until shoulder 72 abuts sloped edge 28.

As inside surface 52 of collar 50 passes over apertures 32, inside surface 52 contacts and forces retaining balls 34 inwardly in a radial direction which engage first recessed region 418 such that a secure connection is achieved between receiving member 12 and first conical member 410.

As previously described above, by directing collar 50 along longitudinal axis 19 away from first conical member 410 until tapered portion 74 of collar 50 is positioned over apertures 32, retaining balls 34 are permitted to more freely move outwardly, preferably in a radial direction, until disengaged from first recessed region 418. Once first recessed region 418 is disengaged from retaining balls 34, the user may apply opposing forces along longitudinal axis 19 to break the connection between receiving member 12 and first conical member 410. The user then applies opposing force along longitudinal axis 19 between distal end 468 and one end of the ventilation circuit until the connection is broken between distal end 468 and the ventilation circuit, thereby removing first conical member 410 and second component 464 from the ventilation circuit.

Second conical member 420 which is connected to third component 470 may now be installed in the ventilation circuit in place of the removed first conical member 410 and second component 464. The user grasps the one end of the ventilation circuit previously connected to distal end 468 in one hand and third component 470 in the other hand and directs third distal end 474 of third component 470 toward the one end of the ventilation circuit along longitudinal axis 19 until a secure connection is established between third component 470 and the one end of the ventilation circuit. As previously described above, the user directs first end 17 over second proximal end 424 and applies continued force along longitudinal axis 19 to incrementally pass first end 17 over second proximal end 424 until retaining balls 34 are properly aligned with second recessed region 428. The user then directs collar 50 along longitudinal axis 19 such that collar 50 passes over outside surface 30 until shoulder 72 abuts sloped edge 28. As inside surface 52 of collar 50 passes over apertures 32, inside surface 52 contacts and forces retaining balls 34 inwardly in a radial direction which engage second recessed region 428 such that a secure connection is achieved between receiving member 12 and second conical member 420.

It should also be appreciated that additional component having compatible connecting members may be added or removed from the ventilation circuit and that components may be connected or disconnected in any order using the method previously described.

It should be understood from the foregoing that, while particular embodiments of the invention have been illustrated and described, various modifications can be made thereto without departing from the spirit and scope of the present invention. Therefore, it is not intended that the invention be limited by the specification; instead, the scope of the present invention is intended to be limited only by the appended claims.

What is claimed is:

1. A device for rapidly and securely replacing components having fluid tight connections comprising:
a receiving member having a hollow body including a first end, a second end and an outside surface, said body further having a plurality of apertures formed therethrough each securing a retaining ball in inward and outward movement therein;
a conical member having a proximal end, a distal end and a recessed region defined therebetween, said conical member slideably receivable within said body; and
a collar slidably engageable along said outside surface for urging said retaining balls inwardly, wherein when said first end passes over said proximal end, said collar slideably engages said outside surface thereby urging said retaining balls into secure engagement within said recessed region.

2. The device according to claim 1, wherein said retaining balls move radially inward and outward therein said conical body.

3. The device according to claim 1, wherein said apertures securing said retaining balls have a conical configuration, the diameter of said aperture opposite said outside surface being slightly less than the diameter of said retaining balls for permitting partial inward movement of said retaining balls within said apertures.

4. The device according to claim 1, wherein said conical body further comprises a frustoconical portion formed between said first and said second ends.

5. The device according to claim 1, wherein said collar further comprises a nonslip outside surface.

6. The device according to claim 1 wherein said conical member further comprises a channel formed between said proximal and distal ends for permitting fluid flow therethrough.

7. The device according to claim 1 wherein said body further comprises a channel formed between said first and second ends for permitting fluid flow therethrough.

8. The device according to claim 4 wherein said frustoconical portion further comprises opposing sloped edges.

9. The device according to claim 4 further comprising a conical portion extending from one end of said frustoconical portion.

10. The device according to claim 6 wherein when said retaining balls are urged into said recessed region, secure engagement is established by said retaining balls by forming a region of decreased inside diameter within said channel, said region of decreased inside diameter being less than the outside diameter on either side of said recessed region, thereby permitting substantially no movement between said conical member and said receiving member.

11. The device according to claim 8 wherein said collar further comprises a proximal end, a distal end, and a shoulder extending inwardly from said distal end for abutting one of said opposed sloped edges when said collar slidably engages said outside surface.

12. The device according to claim 11 wherein said conical member further comprises a raised region formed therealong and extending outwardly therefrom for engaging said shoulder.

13. The device according to claim 12 further comprising a resilient member interposed between said raised region and said shoulder for urging said collar along said outside surface for urging said retaining balls inwardly.

14. A method for providing rapid and secure fluid tight connections in a ventilation circuit, comprising the steps of:
a) providing a receiving member having a hollow body defining a first end, a second end and an outside surface, said body further having a plurality of apertures formed therethrough each securing a retaining ball in inward and outward movement therein, a conical member having a proximal end, a distal end and a recessed region, said conical member slideably receivable within said body, and a collar slidably engageable along said outside surface for urging said retaining balls inwardly, wherein when said first end passes over said proximal end, said collar slidably engages said outside surface thereby urging said retaining balls into secure engagement with said recessed region;
b) providing a ventilation circuit having opposing ends; and
c) attaching securely one of said opposing ends of said ventilation circuit to said second end of said receiving member, and the other of said opposing ends of said ventilation circuit to said distal end of said conical member.

15. A method for rapidly and securely replacing components of a ventilation circuit having fluid tight connections, comprising the steps of:
a) providing a first receiving member including a hollow first conical body having a first end, a second end and a first outside surface, said first conical body further having a plurality of apertures formed therethrough each securing a retaining ball in inward and outward movement therein, a conical member having a proximal end, a distal end and a recessed region defined therebetween, said conical member slidably receivable in said first conical body, and a first collar slidably engageable along said first outside surface for urging said retaining balls inwardly, wherein when said first end passes over said proximal end, said first collar slidably engages said first outside surface thereby urging said retaining balls into secure engagement with said recessed region;
b) providing a ventilation circuit having opposing ends, wherein one of said opposing ends of the ventilation circuit attaches securely to said second end of said first receiving member, and the other of said opposing ends of the ventilation circuit attaches securely to said distal end of said conical member;
c) providing a second receiving member including a hollow second conical body having a third end, a fourth end and a second outside surface, said second body further having a plurality of apertures formed therethrough each securing a retaining ball in inward and outward movement therein; said conical member slidably receivable in said second body, a first component having a first proximal end and a first distal end, said first proximal end attaches securely to said fourth end, a second collar, said second collar slidably engages said second outside surface for urging said retaining balls inwardly, wherein when said third end passing over said proximal end, said second collar slidably engages said second outside surface thereby urging said retaining balls into secure engagement with said recessed region;
d) directing said first collar along said outside surface of said first body until said first collar permits said retaining balls sufficient outward movement to disengage from said recessed region;
e) directing said conical member and said first receiving member in opposing directions until separated;
f) disconnecting said second end of said first receiving member from said one of said opposing ends of the ventilation circuit;
g) connecting said first distal end to said one of said opposing ends of the ventilation circuit of step f);
h) directing said third end of said second receiving member over said proximal end, then directing said second collar into slidable engagement with said second outside surface of said second body thereby urging said retaining balls into secure engagement with said recessed region.

16. The method according to claim 15 wherein said step d) directing said first collar longitudinally along said outside.

17. The method according to claim 15 wherein said step e) directing said conical member and said first receiving member longitudinally in opposing directions.

18. The method according to claim 15 wherein said steps f) and g) may precede said step d).

19. The method according to claim 15 wherein said step h) may precede said step f).

20. A method for rapidly and securely replacing components of a ventilation circuit having fluid tight connections, comprising the steps of:
a) providing a receiving member having a hollow conical body including a first end, a second end and a first outside surface, said body further including a plurality of apertures formed therethrough each securing a retaining ball in inward and outward movement therein, a first conical member having a proximal end, a distal end and a first recessed region defined therebetween, said first conical member slidably receivable in said body, and a collar slidably engageable along said first outside surface for urging said retaining balls inwardly, wherein when said first end passes over said proximal end, said collar slidably engages said first outside surface thereby urging said retaining balls into secure engagement with said first recessed region;
b) providing a ventilation circuit having opposing ends; wherein one of said opposing ends of the ventilation circuit attaches securely to said second end of said receiving member, and the other of said opposing ends of the ventilation circuit attaches securely to said distal end of said first conical member;
c) providing a second conical member having a second proximal end, a second distal end and a second recessed region therebetween, said second conical member slideably receivable in said body, a first component having a first proximal end and a first distal end, said first proximal end securely attaching to said second distal end;
d) directing said collar along said first outside surface of said body until said collar permits said retaining balls sufficient outward movement to disengage from said first recessed region;
e) directing said first conical member and said receiving member in opposing directions until separated;
f) disconnecting said distal end of said first conical member from the other of said opposing ends of the ventilation circuit;
g) connecting said first distal end to the other of said opposing ends of the ventilation circuit of step f);
h) directing said first end of said receiving member over said second proximal end, and then directing said collar into slidable engagement with said first outside surface of said body thereby urging said retaining balls into secure engagement with said second recessed region.

21. The method according to claim 20 wherein said step h) may precede said step f).

22. The method according to claim 20 wherein said steps f) and g) may precede said step d).

23. The method according to claim 20 wherein said step d) directing said first collar longitudinally along said outside surface.

24. The method according to claim 20 wherein said step e) directing said conical member and said first receiving member longitudinally in opposing directions.

25. A method for rapidly and securely replacing components of a ventilation circuit having fluid tight connections, said steps comprising:
a) providing a first receiving member having a hollow first conical body including a first end, a second end and a first outside surface, said first body further including a plurality of apertures formed therethrough each securing a retaining ball in inward and outward movement therein, a conical member having a proximal end, a distal end and a recessed region defined therebetween, said conical member slidably receivable in said first body, a first collar slidably engageable along said first outside surface for urging said retaining balls inwardly, wherein when said first end passing over said proximal end, said first collar slidably engaging said first outside surface thereby urging said retaining balls into secure engagement with said recessed region;
b) providing a ventilation circuit including a first component and a second component, each of said first and second components having a proximal end and a distal end, said distal end of each of said first and second components attaches to opposing ends of the ventilation circuit, wherein when said proximal end of said first component attaches securely to said second end of said first receiving member, said proximal end of said second component attaches securely to said distal end of said conical member;
c) providing a second receiving member having a hollow second conical body including a third end, a fourth end and a second outside surface, said second body further having a plurality of apertures formed therethrough each securing a retaining ball in inward and outward movement therein; said conical member slidably receivable in said second body, a third component having a third proximal end and a third distal end, said third proximal end attaches securely to said fourth end, and a second collar, said second collar slidably engages said second outside surface for urging said retaining balls inwardly, wherein said third end passing over said proximal end, said second collar then slidably engages said second outside surface thereby urging said retaining balls into secure engagement with said recessed region;
d) directing said first collar longitudinally along said outside surface of said first body until said first collar permits said retaining balls sufficient outward movement to disengage from said recessed region;
e) directing said conical member and said first receiving member longitudinally in opposing directions until separated;
f) disconnecting said distal end of said first component from one of said opposing ends of the ventilation circuit;
g) connecting said third distal end to said opposing end of the ventilation circuit of step f);
h) directing said third end of said second receiving member over said proximal end, then directing said second collar into slidable engagement with said second outside surface of said second body thereby urging said retaining balls into secure engagement with said recessed region.

26. The method according to claim 25 wherein said steps f) and g) may precede said step d).

27. The method according to claim 25 wherein said step h) may precede said step f).

28. A method for rapidly and securely replacing components of a ventilation circuit having fluid tight connections, said steps comprising:
a) providing a receiving member having a hollow conical body including a first end, a second end and a first outside surface, said body further having a plurality of apertures formed therethrough each securing a retaining ball in inward and outward movement therein, a first conical member having a proximal end, a distal end and a first recessed region defined therebetween, said first conical member slidably receivable in said body, and a collar slidably engageable along said first outside surface for urging said retaining balls inwardly, wherein when said first end passes over said proximal end, said collar then slidably engages said first outside surface thereby urging said retaining balls into secure engagement with said first recessed region;
b) providing a ventilation circuit including a first component and a second component, each said first and second components having a proximal and a distal end, said distal end of each said first and second component attaches to opposing ends of the ventilation circuit; wherein when said proximal end of said first component attaches securely to said second end of said receiving member, said proximal end of said second component attaches securely to said distal end of said first conical member;
c) providing a second conical member having a second proximal end, a second distal end and a second recessed region defined therebetween, said second conical member slideably receivable in said conical body, a third component having a third proximal end and a third distal end, said third proximal end securely attaches to said second distal end;
d) directing said collar longitudinally along said first outside surface of said body until said collar permits said retaining balls sufficient outward movement to disengage from said first recessed region;
e) directing said first conical member and said receiving member longitudinally in opposing directions until separated;
f) disconnecting said distal end of said second component from one of said opposing ends of the ventilation circuit;
g) connecting said third distal end to said opposing end of the ventilation circuit of step f);
h) directing said first end of said receiving member over said second proximal end, then directing said collar into slidable engagement with said first outside surface of said body thereby urging said retaining balls into secure engagement with said second recessed region.

29. The method according to claim 28 wherein said step h) may precede said step f).

30. The method according to claim 28 wherein said steps f) and g) may precede said step d).
